(19) United States
(12) Patent Application Publication
(10) Pub. No.: US 2009/0277591 A1
(43) Pub. Date: Nov. 12, 2009

(54) Auxiliary fixture for debonding sliders and method for manufacturing sliders using the same

(75) Inventors: ShiXing Zhao, Dongguan City (CN); Masahiro Kondoh, Hong Kong (CN); FangYi Ning, Dongguan (CN); Takeshi Nakada, Hong Kong (CN); Shingcheong Lau, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/216,462

(22) Filed: Jul. 3, 2008

(30) Foreign Application Priority Data
May 12, 2008 (CN) 200810096519.9

(51) Int. Cl. G11B 5/127

(52) U.S. Cl. 156/584; 29/603.18

(57) ABSTRACT

An auxiliary fixture for debonding sliders from an exposure jig and receiving the sliders includes a debonding tray. A top surface of the debonding tray forms a plurality of slider pockets arranged in an array. Every two adjacent slider pockets in every column of the array are separated by an interval wall such that every interval wall corresponds to one slider pocket. One side of each interval wall that forms an inner wall of the corresponding slider pocket is an incline such that the interval wall has a structure tapering from the bottom up. The inclines of the interval walls in the same column of the array incline to the same side and the inclines of the interval walls in two adjacent columns of the array incline to opposite sides such that every two adjacent interval walls in every row of the array form side walls of each other's slider pockets. The present invention also discloses a method for manufacturing sliders with the auxiliary fixture.

### FIELD OF THE INVENTION

The present invention relates to a device and method for manufacturing information recording disk drive units, particularly to a device and method for manufacturing sliders used in the information recording disk drive units and, more particularly to an auxiliary fixture for debonding sliders from an exposure jig and a method for manufacturing sliders using the auxiliary fixture.

### BACKGROUND OF THE INVENTION

One known type of information storage device is disk drive device that uses magnetic media to store data and a movable slider having a read/write head positioned over the magnetic media to selectively read data from and write data to the magnetic media.

The slider is formed by processing a wafer which is generally used to manufacture sliders through a series of procedures. At first, the wafer is subjected to a lapping process, a cleaning process, a depositing process and an etching process. Then, the processed wafer is sliced into a plurality of row bars by a suitable tool such as a diamond cutting wheel, each row bar including a plurality of slider arrays. Next, each row bar is subjected to a series of subsequent procedures, such as bonding the row bars to an exposure jig for photo processing like photohyalography, and slider array electrical characteristics test. Then, each row bar is cut into individual sliders by a cutter, such as the aforementioned diamond-cutting wheel. After that, non-defective sliders are singled out from all the sliders obtained according to the aforementioned method by a sorting procedure. Then, the non-defective sliders are cleaned and finally, these cleaned and non-defective sliders are assembled to respective disk drive units.

The traditional manufacturing process of sliders generally needs two bonding procedures and two debonding procedures. As shown in FIGS. 1a-1b, a plurality of row bars 100 are bonded to an exposure jig 110 by adhesive and processed with a series of processing procedures, and then a first debonding procedure is executed, that is debonding the row bars 100 from the exposure jig 110. The first debonding is performed by firstly, fixing the exposure jig 110 with the row bars 100 attached thereon on a row bar device 130 by wires 120, and then placing the exposure jig 110 and the device 130 into suitable solution 140 to dissolve the adhesive. After that, the row bar 100 needs to be cut into individual sliders. To facilitate the cutting operation, the row bars 100 are usually fixed on a transfer tool by adhesive or wax provisionally, which is the second bonding procedure. Then cut the row bar 100 into individual sliders by cutting tools. Since the sliders are still fixed on the transfer tool by the adhesive, the adhesive must be removed to debond the sliders from the transfer tool, which is the second debonding procedure. The separated sliders are positioned in turn in a debonding tray to facilitate the selecting work of the eligible sliders in the subsequent process. There are many methods for debonding the sliders from the transfer tool and positioning them into the debonding tray in the field, which will be respectively described hereinafter.

FIGS. 1c-1g illustrate a conventional hot plate debonding method. As shown in FIGS. 1c-1d, a group of sliders are fixed on a surface of a transfer tool 102 by adhesive. Then, as shown in FIG. 1e, the transfer tool 102 is mounted on a hot plate 103. Next, the hot plate 103 is heated to a predetermined temperature so that the transfer tool 102 is baked by a high temperature. When the temperature reaches the melting point of the adhesive, the adhesive melts such that the sliders 101 are free from restraint of the adhesive. Finally, the sliders 101 are transferred to respective pockets 106 of a debonding tray 105 shown in FIG. 1g one by one with a pair of tweezers 104 shown in FIG. 1f.

The above method can effectively separate the sliders from the transfer tool and position them into the debonding tray efficiently. However, since each slider is small in volume and weight, and the space between two adjacent sliders is very narrow, slight jolting or air-flowing (such as breeze) can cause the sliders to move. Accordingly, during the process of transferring a great number of sliders from the transfer tool to the debonding tray one by one via the tweezers, the sliders are easily disordered due to jolting or collision (for example body tremor of an operator or collision between the tweezers and the sliders) such that the sliders are mixed with each other, thus making the sliders unable to be stored into suitable pockets of the debonding tray according to their original order on the transfer tool. The disorder of the sliders in the debonding tray makes it impossible for an operator to directly implement slider selection work according to both electric performances of the sliders tested before the sliders are cut out and the original relative locations of the sliders. On the contrary, if such disorder of the sliders happens, it is inevitable to read one by one identifying numbers formed on deposition surfaces of the sliders. The identifying number is marked on the deposition surface of each slider in size of about 5×10 μm per word. However, as the deposition surface of each slider in the pocket is placed to be parallel to sidewalls of the pocket, the operator can not catch sight of the identifying numbers directly with a microscope; and resultantly, the sliders have to be taken out from the slider pockets one by one via tools such as a pair of tweezers to ascertain the identifying number of each slider via the microscope, thus resulting in confusion of the sliders in the pockets of the debonding tray, and making it difficult to select sliders. In addition, the slider debonding method uses high temperature which may easily hurt the operator during operation. For example, the operator may be hurt by the hot plate, and moreover, the manual operation suffers from low work efficiency as well.

FIGS. 2a-2d show a process of debonding sliders from a transfer tool and placing them into a debonding tray using a solvent debonding method. As shown in FIG. 2a, a transfer tool 202 with a number of sliders 201 attached thereon by adhesive is positioned in a tank 203 containing solution 205. The solution 205, such as solution containing NMP (N-Methyl Pyrrolidone) or IPA (Isopropyl Alcohol) solvent dissolves the adhesive such that the connection between the sliders 201 and the transfer tool 202 is eliminated. After that, as shown in FIG. 2b, the solution 205 is expelled from the tank 203 through a discharging valve 206. During the process of dissolving the adhesive by the solution 205, an ultrasonic device 204 may also be used to accelerate dissolving speed. After that, a tweezers (as shown in FIG. 2c) is used to transfer the sliders 201 from the transfer tool 202 to pockets 209 of the debonding tray 208 shown in FIG. 2d. Though the solvent debonding method is relatively safe (without danger of high temperature burning) compared with the hot plate debonding method, the method still use the tweezers to transfer sliders by manual; accordingly, the problem of sliders' confusion exists, thus making it difficult to select the sliders in a subsequent process. In addition, the manual operation causes low work efficiency.

There is also an improved solvent debonding method used in the field. As shown in FIGS. 3a-3e, a transfer tool 302 with a group of sliders 301 attached on one surface thereof by adhesive is fixed on a carrying plate 303. The carrying plate 303 is further mounted on a debonding tray 304 for receiving sliders, thus forming an assembly 300. The carrying plate 303 has many guide posts 305 formed thereon and the debonding tray 304 has many guide bushings 306 corresponding to the guide posts 305. The guide posts 305 are inserted into the corresponding guide bushings 306 respectively, thus achieving alignment of the carrying plate 303 with the debonding tray 304, and ensuring that the sliders 301 are aligned with the pockets 309 of the debonding tray 304. As shown in FIG. 3c, the assembly 300 is dipped in some solution 307. The solution 307dissolves the adhesive such that the connection between the sliders 301 and the transfer tool 302 is eliminated. Each slider directly drops into respective pocket 309 located therebelow due to gravity. In comparison with the above-mentioned slider debonding methods, as the improved slider debonding method can quickly transfer all the sliders to the pockets of the debonding tray once the sliders are separated from the transfer tool, it has higher work efficiency. However, since the cutting pitch along which the row bar is cut into individual sliders is very narrow, and accordingly, for ensuring that the separate sliders can accurately fall into respective pockets, the pitch (denoted with numeral 311 in FIG. 3e) between the pockets of the debonding tray has to conform to the above cutting pitch. That is, the pitch must also be very narrow. However, as the slider is small in size and weight, it is susceptible to external jolting or air-flowing such that the slider is displaced easily, and therefore, the slider may easily drop into another pocket by mistake, thus causing slider confusion and complicating later slider-selecting process. Moreover, the very narrow pitch between the pockets increases manufacture cost because narrower pitch will cause the manufacture process to become more difficult.

There further exists a slant solvent debonding method used in this field. As shown in FIGS. 4a-4b, an auxiliary fixture 400 for debonding sliders 408 from a transfer tool 403 includes a locating device 407 for locating the transfer tool 403, a debonding tray 401 under the locating device 407 for receiving sliders, a guide plate 402 parallel positioned between the locating device 407 and the debonding tray 401, and a base plate 411 for carrying the locating device 407, the debonding tray 401 and the guide plate 402. Referring to FIGS. 4c-4d, the debonding tray 401 has at least a column of first pockets 412 having the same direction as the sliders arranged on the transfer tool 403, and at least a column of second pockets 413 which is parallel to the column of first pockets 412. Between every two adjacent first pockets 412 is a stage 414 whose length in the arranged direction of the first pockets, namely, the space d between two adjacent first pockets 412, is larger than the length of the slider in the same direction. The second pockets 413 and the adjacent stages 414 thereof are at the same position in the arranged direction of the first pockets 412. Put the auxiliary fixture 400 into a container 437 with some suitable solution 438 inside by a wedge block 439, and make the positions of the first pockets 412 higher than that of the second pockets 413. As the solution 438 dissolves the adhesive on the transfer tool 403, a group of the sliders 408 break away from the transfer tool 403. The sliders 408a directly drop into the first pockets 412 thereunder due to gravity, while the sliders 408b drop onto the stages 414 and then slip into the second pockets 413 due to gravity. Thus all the sliders 408a, 408b are debonded and housed. In comparison with the aforementioned methods for debonding sliders, this method can accurately transfer all the sliders separated from the transfer tool to the slider pockets in a lump and decrease the mixing rate to 0.8%-2%, so it is convenient for the selecting work of eligible sliders in the subsequent process. However, this method needs too many parts and those parts are hard to be assembled because the positions of the transfer tools 403 must be calibrated under a microscope one by one. In addition, this method needs a lot of time spent in assembling the guide plate 402, and it needs maintenance often, so it is inconvenient.

In addition, manufacturing sliders with abovementioned methods and devices needs two bonding procedures and two debonding procedures as described above. If only conducting one bonding procedure and one debonding procedure, namely, bonding the row bars on the exposure jig for photo processing and so on, and cutting the row bars into sliders directly on the exposure jig, and then debonding the sliders using the abovementioned methods, it is too hard to operate even if the operators pick up the sliders with tweezers manually because the spaces between the row bars and the cutting pitch along which the sliders are cut off are very small. Thus, it is needed to transfer the row bars to the transfer tool for increasing the spaces therebetween before cutting the row bars. Accordingly, these methods for manufacturing sliders need two bonding procedures and two debonding procedures, so these methods are complicate and the manufacturing efficiency is low.

Hence, a need has arisen for providing an improved auxiliary fixture for debonding sliders and a method for manufacturing sliders using the auxiliary fixture to overcome the abovementioned problems.

### SUMMARY OF THE INVENTION

Accordingly, an objective of the present invention is to provide an auxiliary fixture for debonding sliders which is capable of avoiding or decreasing the confusion of the sliders during the process of transferring the sliders from an exposure jig to a debonding tray. Moreover, the auxiliary fixture has a simple structure such that it can be assembled conveniently and maintained easily.

Another objective of the present invention is to provide a method for manufacturing sliders with the auxiliary fixture for debonding sliders which is capable of simplifying the process and increasing the efficiency.

To achieve the above-mentioned objectives, the present invention provides an auxiliary fixture for debonding sliders from an exposure jig and receiving the sliders that includes a debonding tray. A top surface of the debonding tray defines a plurality of slider pockets arranged in an array. Every two adjacent slider pockets in every column of the array are separated by an interval wall such that every interval wall corresponds to one slider pocket. One side of each interval wall that forms an inner wall of the corresponding slider pocket is an incline such that the interval wall has a structure tapering from bottom up. The inclines of the interval walls in the same column of the array incline to the same side, and the inclines of the interval walls in two adjacent columns of the array incline to opposite sides such that every two adjacent interval walls in every row of the array form the side walls of each other's slider pockets.

According to one embodiment of the present invention, the debonding tray comprises an upper debonding tray and a lower debonding tray. The upper debonding tray defines a plurality of parallel slots and forms a crossbeam between every two adjacent slots, and a top surface of each crossbeam forms a column of the slider pockets. All the inclines of the interval walls formed on the upper debonding tray incline to the same direction. The lower debonding tray forms a plurality of parallel ribs, a top surface of each rib forms a column of the slider pockets, and all the inclines of the interval walls formed on the lower debonding tray incline to the same direction which is opposite to the direction to which the inclines of the upper debonding tray incline. The ribs of the lower debonding tray insert into the corresponding slots of the upper debonding tray.

According to another embodiment of the present invention, the debonding tray is one-piece in structure.

Preferably, a vertical cross-section of the slider pocket is about a triangle.

Preferably, the angle between the incline of the interval wall and the level is in the range from 10 to 50 degree so as to conveniently guide the sliders into the corresponding slider pockets without confusion.

Preferably, the bottom of the slider pocket is further recessed to form a recess. The debonding tray defines a through hole in the incline of the interval wall corresponding to each slider pocket and run through the debonding tray, and between every two adjacent interval walls in each row of the array there is a gap so that the solution can soak in to accelerate dissolving the adhesive between the sliders and the exposure jig, and in turn, make the slider separate from the exposure jig. In addition, the sliders can be gripped by vacuum through the through holes so as to prevent the sliders from moving after they drop into the slider pockets.

A method for manufacturing sliders using the above-mentioned auxiliary fixture comprises steps of:

(1) bonding a plurality of row bars to an exposure jig by adhesive;

(2) processing the row bars with a photo process;

(3) cutting the row bars into individual sliders directly on the exposure jig;

(4) providing an auxiliary fixture as described above, and positioning the exposure jig above the debonding tray with the sliders being one-to-one alignment with the slider pockets; and

(5) soaking the assembly of the exposure jig and the auxiliary fixture horizontally in a container with some solution inside, dissolving the adhesive with the solution to make the sliders debond from the exposure jig and drop into the corresponding slider pockets.

The solution is some solution containing NMP or IPA solvent.

As an embodiment of the present invention, when the sliders are soaked in the solution, an ultrasonic vibration is provided to accelerate debonding the sliders from the exposure jig.

In an embodiment of the present invention, a row of sliders cut from one row bar are aligned with a row of slider pockets of the debonding tray and a column of sliders from different row bars are aligned with a column of slider pockets of the debonding tray such that the sliders are one-to-one alignment with the slider pockets.

The functional effect of the auxiliary fixture of the present invention is that one side of each interval wall in every column is an incline such that the interval wall has a structure tapering from the bottom up and the slider pocket has a big-end-up structure, which is convenient for guiding the sliders in every column into the slider pockets in the corresponding column, and in turn, makes sure that the adjacent sliders in the same column are separated. Moreover, since the planes of the inclines of every two adjacent interval walls in every row are crossed with each other, the two interval walls form side walls of each other's slider pockets so as to limit the sliders' movement, and in turn, prevent the adjacent sliders in rows from mixing, thus, make sure that the adjacent sliders in every row are separated. Accordingly, the sliders separated from the exposure jig can accurately drop into the corresponding slider pockets without confusion. Furthermore, the fixture has a few components which can be assembled conveniently, and the fixture does not need maintenance too often.

The functional effect of the method for manufacturing sliders of the present invention is that the method can debond sliders arranged in an array, which has small spaces between every two adjacent columns and every two adjacent rows, from the exposure jig and accurately receive the sliders in the debonding tray, so the row bars can be cut into sliders directly on the exposure jig rather and do not need to transfer the row bars, and in turn, saves one bonding procedure and one debonding procedure, that is to say, the whole process of manufacturing sliders only needs one bonding procedure and one debonding procedure, therefore simplifying the process and increasing the efficiency.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

FIG. 1a is a plan view of an exposure jig with a group of row bars attached on a surface thereof;

FIG. 1b is a state view illustrating the exposure jig mounted on a device and positioned in a container with some solution inside in a first bonding procedure;

FIG. 1c is a plan view showing that the row bars separated from the exposure jig are bonded to a transfer tool and cut into individual sliders on the transfer tool;

FIG. 1d is a partially enlarged view of of an encircled portion labeled A of FIG. 1c;

FIG. 1e is a plan view showing that a transfer tool and sliders of a traditional hot plate debonding method mounted on a hot plate for secondly debonding the sliders;

FIG. 1f is a front view showing a tweezers used for transferring the debonded sliders from the transfer tool to a debonding tray in the traditional hot plate debonding method;

FIG. 1g is a plan view showing a structure of the debonding tray used in the traditional hot plate debonding method;

FIG. 2a is a state view illustrating that a transfer tool with sliders attached thereon is positioned in a container with some solution inside for secondly debonding the sliders in a traditional solution debonding method;

FIG. 2b is a state view showing that the solution in the container shown in FIG. 2a is expelled out;

FIG. 2c is a tweezers used for transferring the debonded sliders from the transfer tool to a debonding tray in the method shown in FIG. 2a;

FIG. 2d is a plan view showing a structure of the debonding tray for receiving sliders in the traditional solution debonding method;

FIG. 3a is an exploded view of an assembly used in an improved solution debonding method;

FIG. 3b is a schematic view of the structure shown in FIG. 3a after assembled;

FIG. 3c is a state view showing the assembly shown in FIG. 3b soaking in some solution for secondly debonding the sliders;

FIG. 3d is a schematic view illustrating a structure of a debonding tray for receiving debonded sliders in the improved solution debonding method;

FIG. 3e is a partially enlarged view of an encircled portion labeled B of FIG. 3d;

FIG. 4a is an exploded view of an fixture used in a slant solution debonding method;

FIG. 4b is a schematic view of a structure shown in FIG. 4a after assembled;

FIG. 4c is a schematic view illustrating a structure of a debonding tray for receiving debonded sliders shown in FIG. 4a;

FIG. 4d is a partially enlarged view of an encircled portion labeled C of FIG. 4d;

FIG. 4e is a state view showing the fixture shown in FIG. 4b soaking in some solution for secondly debonding the sliders;

FIG. 4f is a state view showing that the sliders of the fixture shown in FIG. 4e separate from the transfer tool and drop into pockets of the debonding tray;

FIG. 4g is a cross-sectional view of a structure shown in FIG. 4f taken along Line H-H which illustrates the state that a first group of sliders are all received in a group of first pockets of the debonding tray;

FIG. 4h is a cross-sectional view of the structure shown in FIG. 4f taken along Line K-K which illustrates the state that a second group of sliders are all received in a group of second pockets of the debonding tray;

FIG. 5a is an exploded view of an auxiliary fixture of a first embodiment of the present invention;

FIG. 5b is a schematic view of the auxiliary fixture shown in FIG. 5a after assembled;

FIG. 6a is a plan view illustrating that a group of row bars are bonded to an exposure jig in the present invention;

FIG. 6b is a partially enlarged perspective view illustrates that the row bars shown in FIG. 6a are sliced into individual sliders on the exposure jig;

FIG. 7a is a top view of an exposure jig holder shown in FIG. 5a;

FIGS. 7b-7c are schematic views showing the assemblying process of the exposure jig with sliders and the exposure jig holder;

FIG. 8a is an exploded perspective view of the debonding tray shown in FIG. 5a;

FIG. 8b is an enlarged view of an encircled portion labeled D of FIG. 8a;

FIG. 8c is an enlarged view of an encircled portion labeled E of FIG. 8a;

FIG. 9a is a top plan view of the upper debonding tray shown in FIG. 8a;

FIG. 9b is a cross-sectional view of FIG. 9a taken along line I-I;

FIG. 9c is a cross-sectional view of FIG. 9a taken along line II-II which shows a column of pockets of the upper debonding tray in direction Y;

FIG. 9d is a partially enlarged top view of the column of pockets of the upper debonding tray in direction Y;

FIG. 9e is a partially enlarged sectional view of the column of pockets of the upper debonding tray in direction Y;

FIG 10a is a top plan view of the lower debonding tray shown in FIG. 8a;

FIG. 10b is a cross-sectional view of FIG. 10a taken along line III-III;

FIG. 10c is cross-sectional view of FIG. 10a taken along line IV-IV which shows a column of pockets of the lower debonding tray in direction Y;

FIG. 10d is a partially enlarged top view of the column of pockets of the lower debonding tray in direction Y;

FIG. 10e is a partially enlarged sectional view of the column of pockets of the lower debonding tray in direction Y;

FIG. 11a is a perspective view of the debonding tray after assembled;

FIG. 11b is an enlarged view of the encircled portion labeled F of FIG. 11a;

FIG. 11c is a cross-sectional view of FIG. 11a taken along line V-V;

FIG. 11d is a partially enlarged top view of FIG. 11a and shows two adjacent columns of pockets which provide several rows of pockets formed in direction X;

FIG. 11e is a partially enlarged sectional view of the two columns of pockets shown in FIG. 11c;

FIG. 12a is a top plan view of a debonding tray holder shown in FIG. 5a;

FIGS. 12b-12c are schematic views showing that the debonding tray and the debonding tray holder are assembled;

FIG. 13 is a state view illustrating an auxiliary fixture of the present invention soaking in some solution for debonding sliders;

FIG. 14 is a flow chart of a method for manufacturing sliders according to the present invention;

FIGS. 15a-15c are schematic views illustrating the process of the sliders dropping from the exposure jig into the corresponding pockets;

FIG. 16 is a state view illustrating that the sliders on the exposure jig debond from the exposure jig and drop into pockets of the debonding tray;

FIG. 17 is a cross-sectional view of a debonding tray according to a second embodiment of the present invention;

FIG. 18a is a perspective view of a debonding tray according to a third embodiment of the present invention; and

FIG. 18b is a partially enlarged view of the debonding tray shown in FIG. 18a.

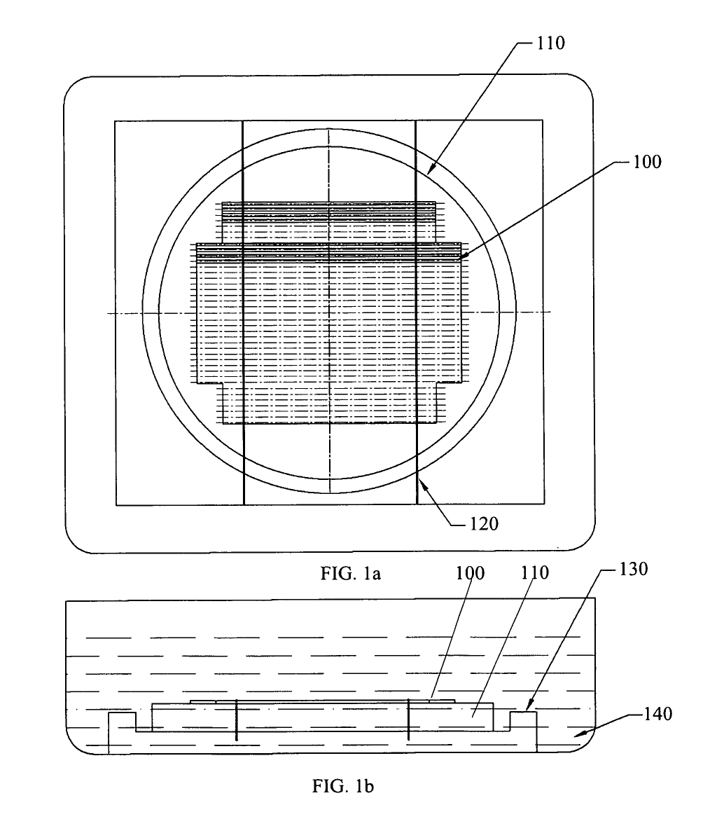

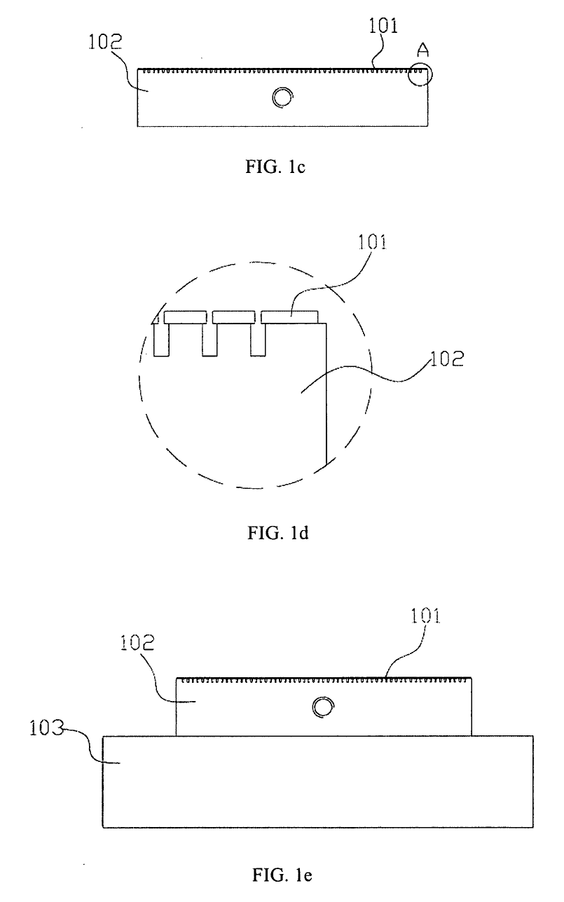

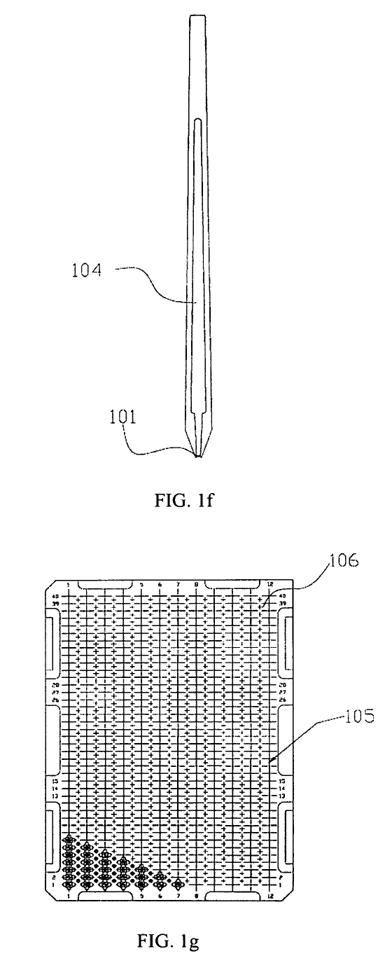

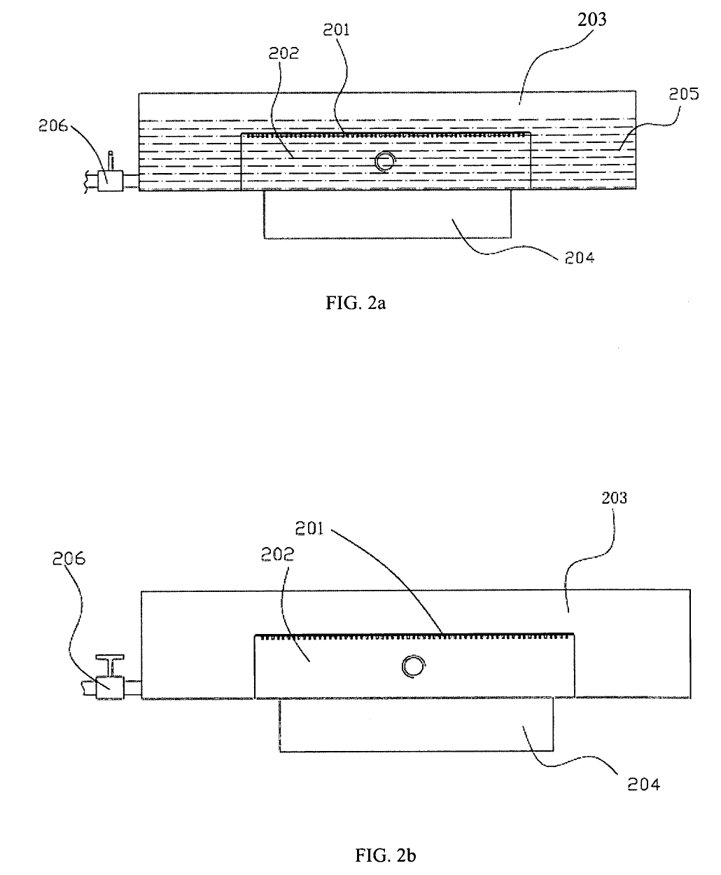

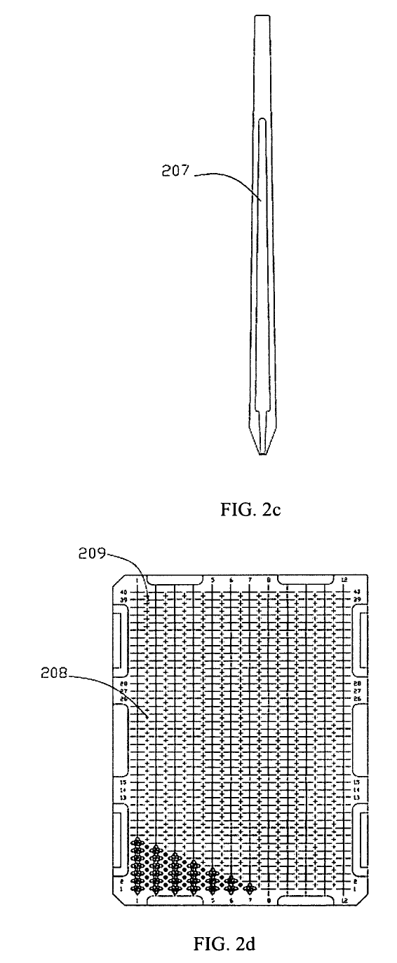

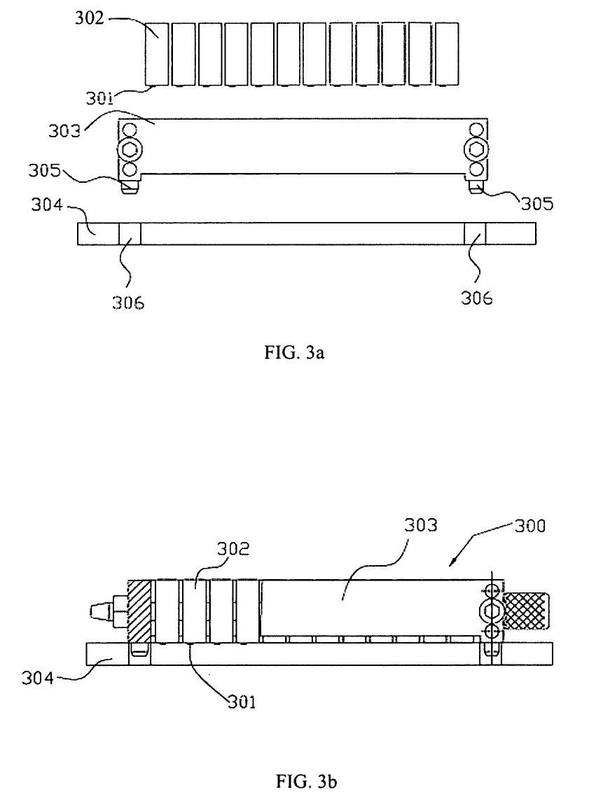

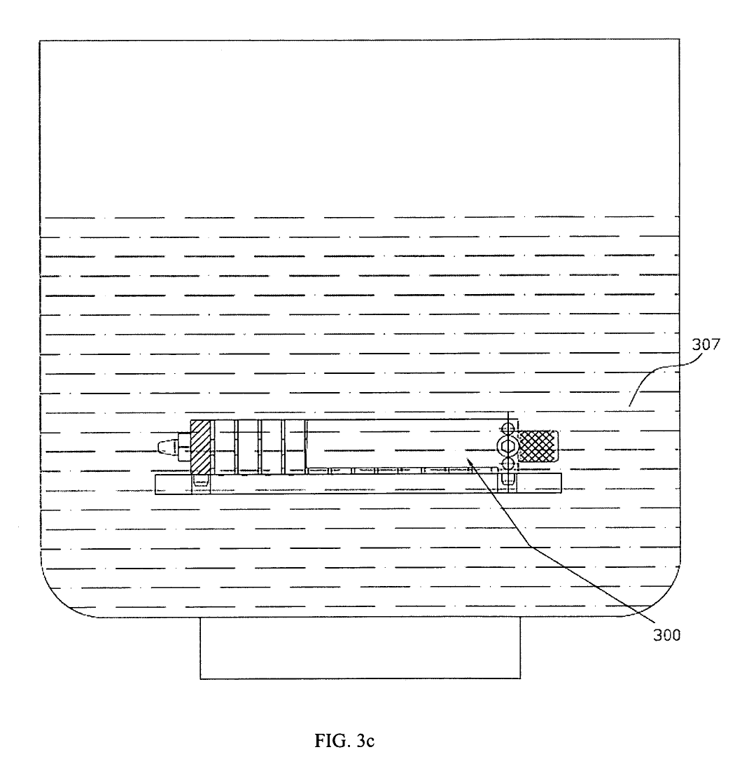

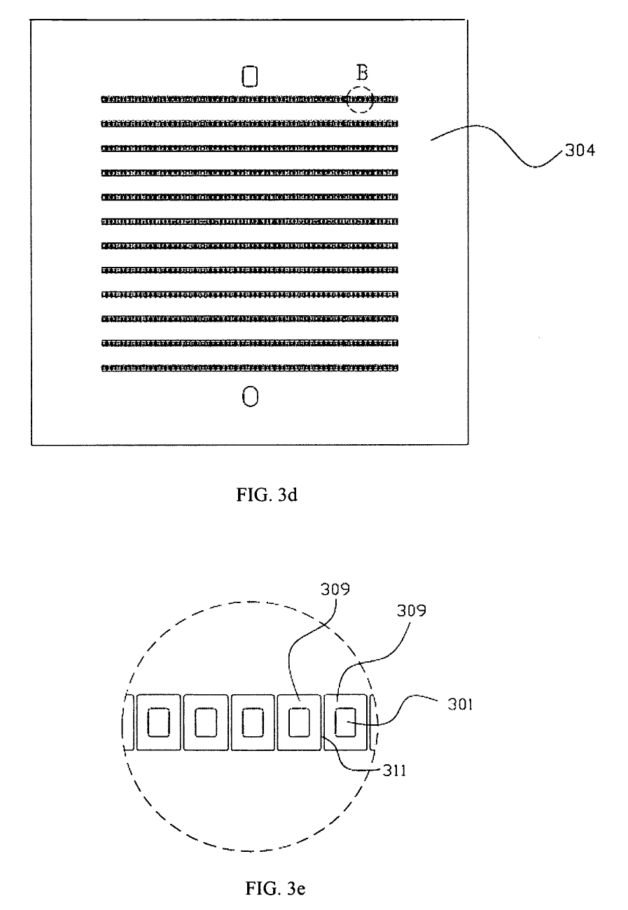

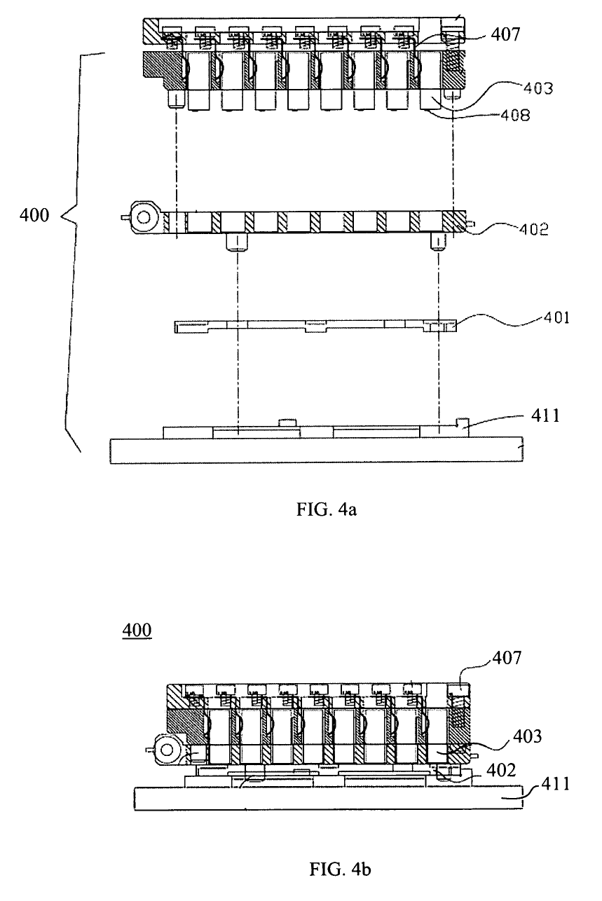

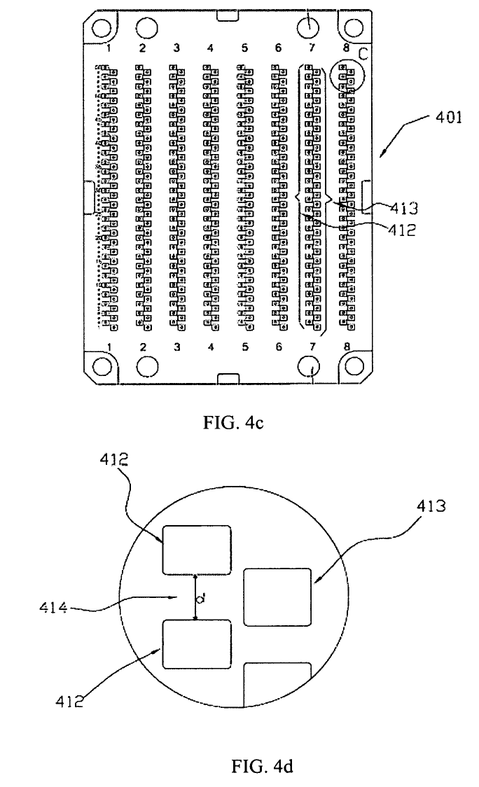

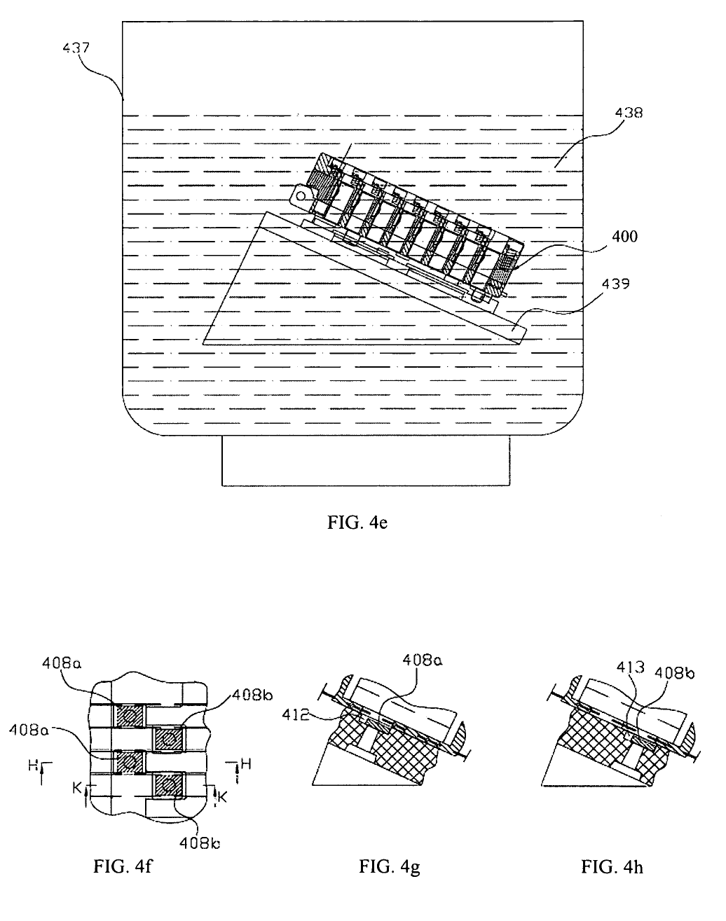

### DETAILED DESCRIPTION OF ILLUSTRATED EMBODIMENTS

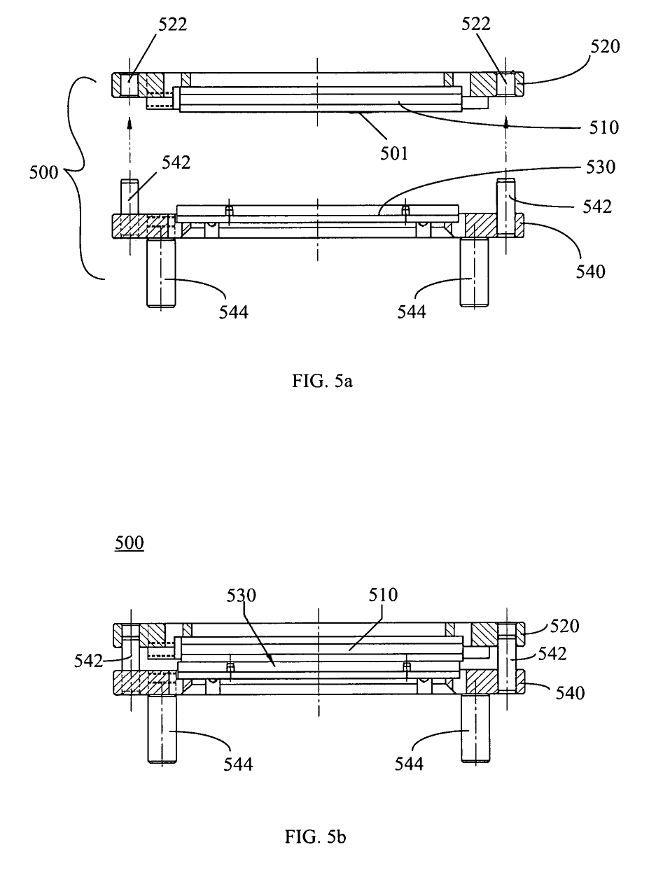

Various preferred embodiments of the invention will now be described with reference to the figures, wherein like reference numerals designate similar parts throughout the various views. FIGS. 5a-5c shows an auxiliary fixture 500 for debonding sliders 501 from an exposure jig 510 according to a first embodiment of the present invention. The auxiliary fixture 500 includes an exposure jig holder 520 for fixing the exposure jig 510, a debonding tray 530 and a debonding tray holder 540 for fixing the debonding tray 530.

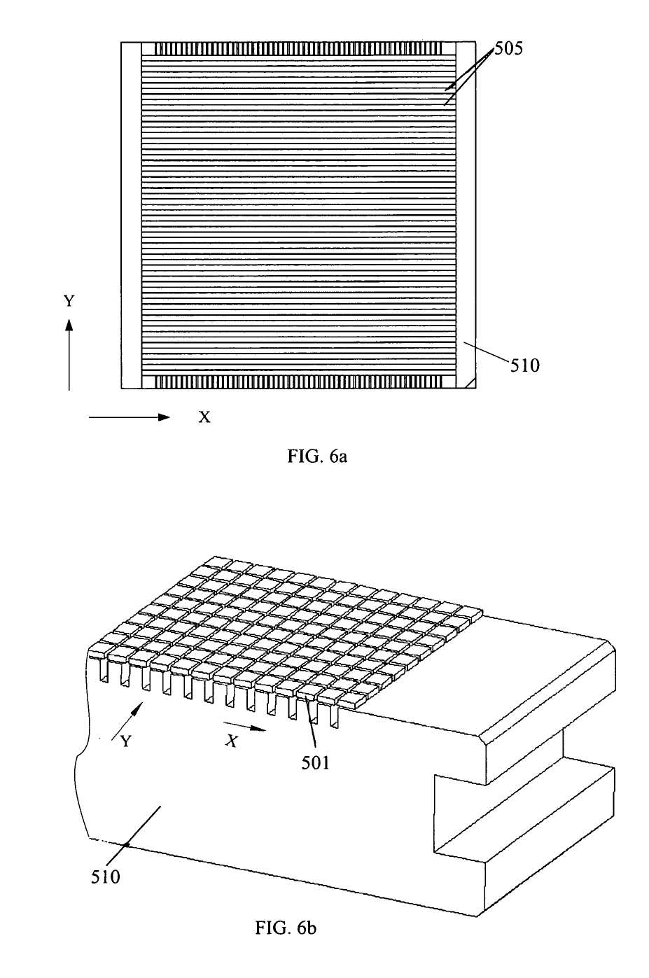

Firstly, the formation of the sliders 501 is introduced briefly. As we know, the sliders are fabricated with row bars. Concretely, referring to FIG. 6a and FIG. 6b, a group of row bars 505 are parallel bonded to the exposure jig 510 in direction Y, so each row bar extends in direction X. And then the group of row bars 505 are cut several times in direction Y at a suitable interval on the exposure jig 510 such that every row bar 505 is cut into a plurality of individual sliders 501, which arranges in an array and are still bonded to the exposure jig 510. Now we define direction X as row and direction Y as column. Accordingly, the sliders 501 in each row belong to one row bar 505, while the sliders 501 in each column belong to different row bars 505.

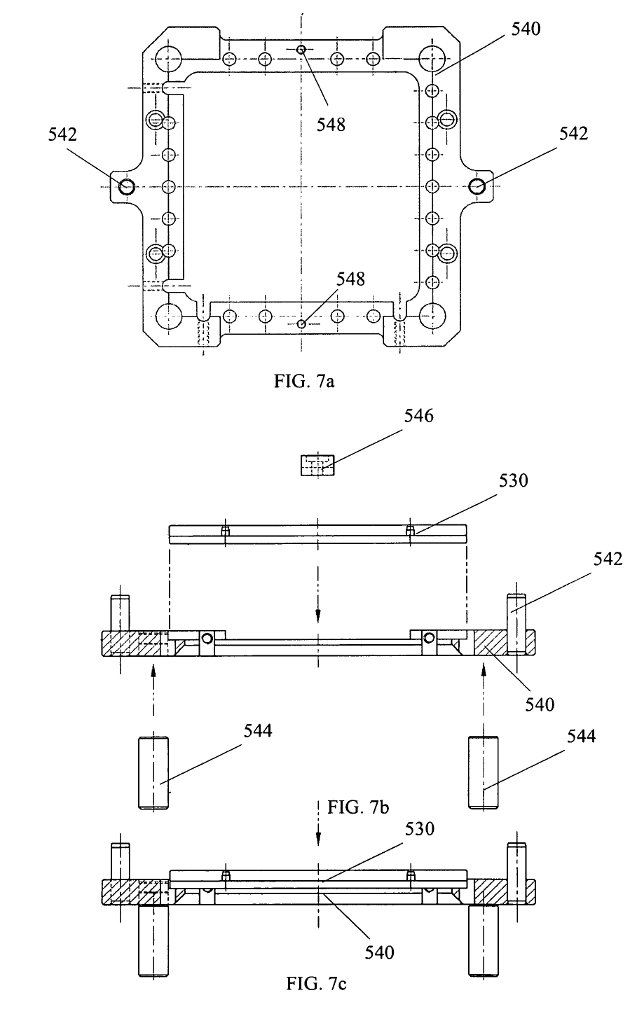

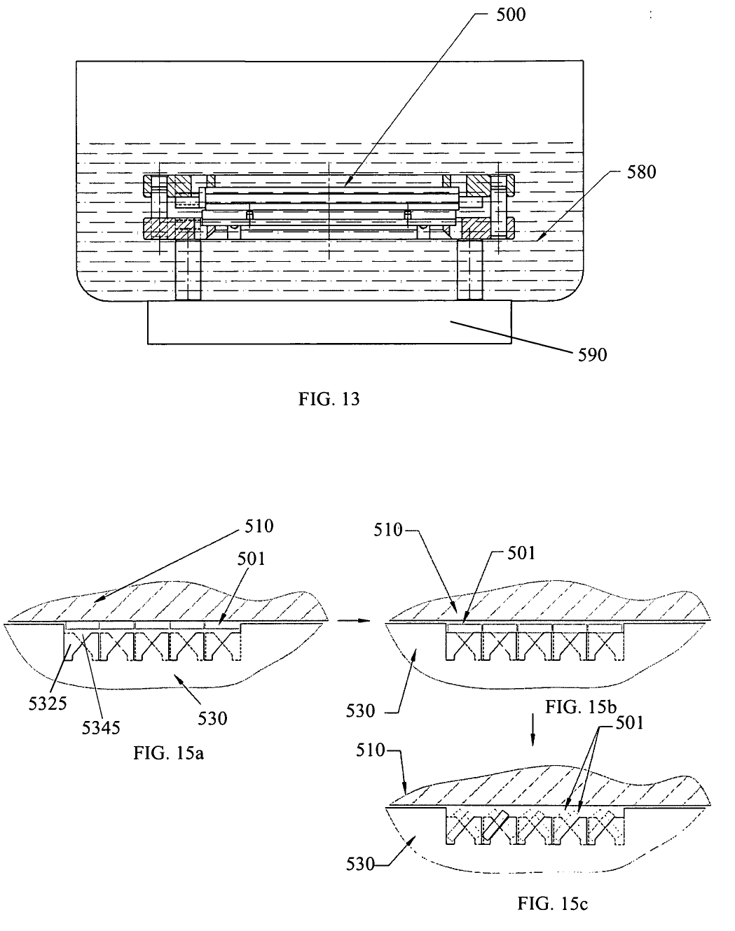

As shown in FIGS. 7a-7c, the debonding tray holder 540 is about a square frame which is hollowed out in the center thereof and has four side bars connecting with their adjacent side bars respectively. The left and right side bars each have an aligning pillar 542 extending upward and a supporting leg 544 extending downward at its middle position, while the front and rear side bars each have a mounting hole 548 formed at the middle position thereof. The aligning pillars 542 and the supporting legs 544 may be integrated with the debonding tray 540 or individual elements mounted on the debonding tray 540 by mechanical fixing, both of which are well known to persons ordinarily skilled in the art, and a detailed description of which is omitted herefrom. The aligning pillars 542 are used for engaging with the exposure jig holder 520, which will be described in detail hereinafter, and the supporting legs 544 are used to steadily support the assembly of the auxiliary fixture 500 and the exposure jig 510 in the container with some solution, as shown in FIG. 13. The mounting holes 548 are engaged with first connection elements 546 to fix the debonding tray 530 to the debonding tray holder 540. The first connection elements 546 can be screws or other similar elements.

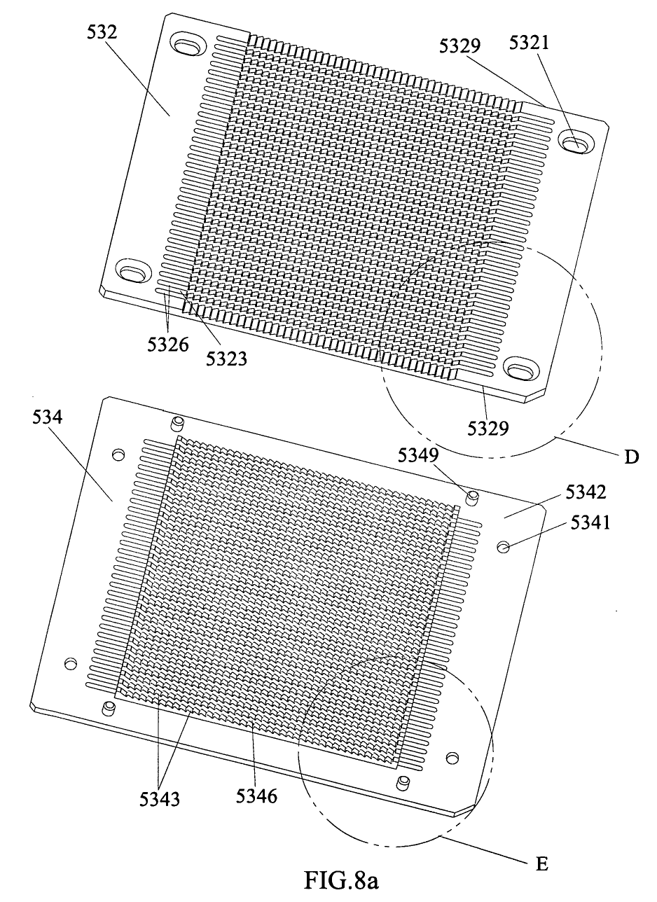

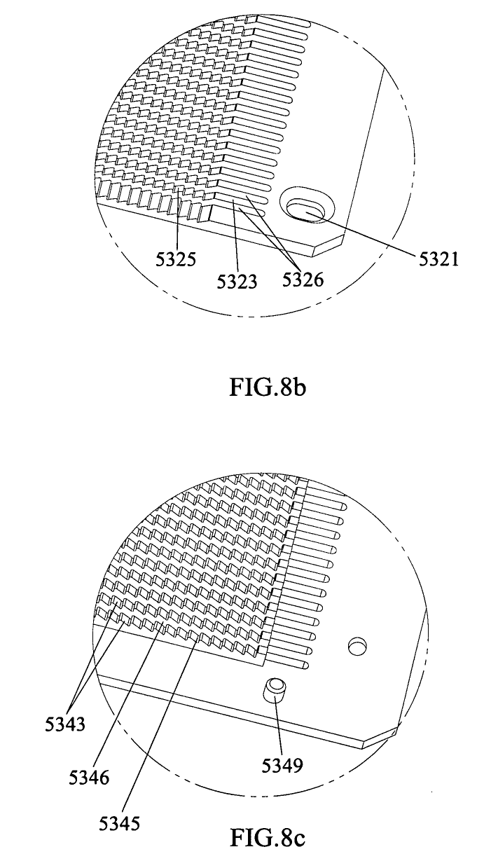

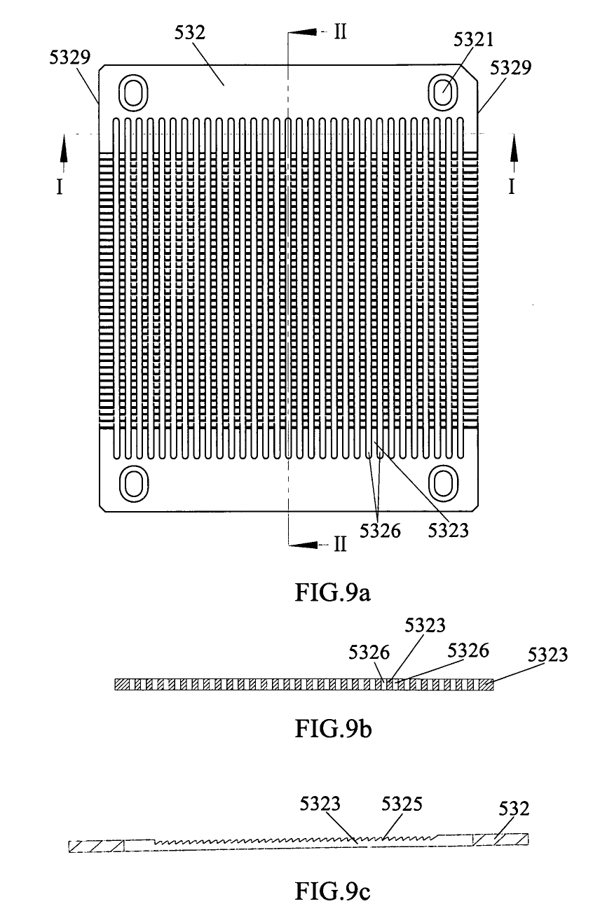

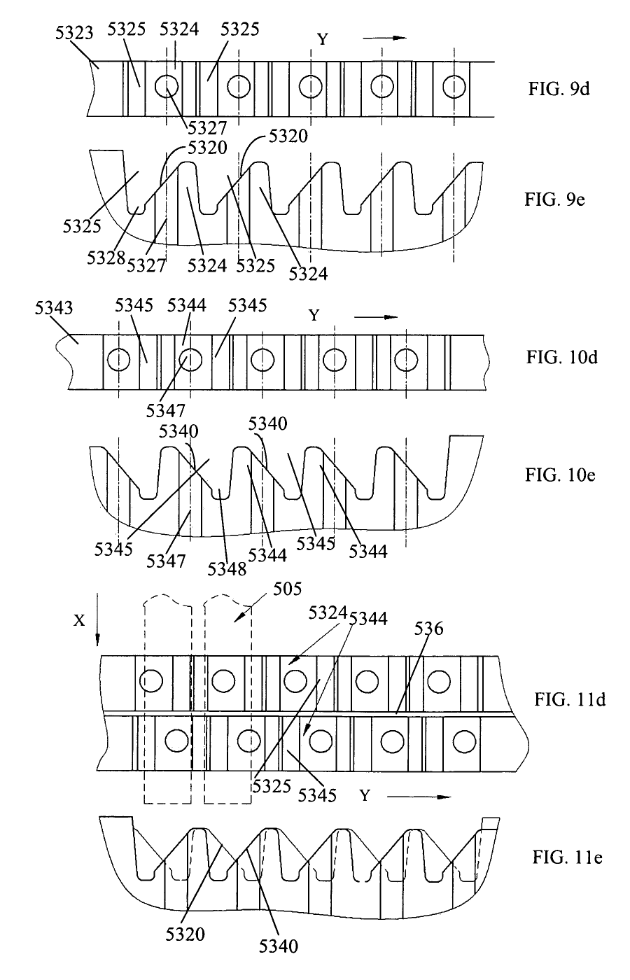

FIG. 8a is an exploded perspective view of the debonding tray 530 consisting of an upper debonding tray 532 and a lower debonding tray 534. In junction with FIG. 8b and FIGS. 9a-9e, the upper debonding tray 532 is roughly square and has two opposite sides 5329. And the upper debonding tray 532 defines a top mounting hole 5321 at each of its four comers for assembling the upper debonding tray 532 with the lower debonding tray 534. A top surface of the upper debonding tray 532 defines a plurality of slots 5326 which are parallel to the sides 5329, as shown in FIG. 9b. The parallel slots 5326 run through the upper debonding tray 532 from top to bottom, and the upper debonding tray forms a crossbeam 5323 between every two adjacent slots 5326. As shown in FIGS. 9c-9e, the top surface of every crossbeam 5323 forms a column of slider pockets 5325. Every two adjacent slider pockets 5325 in each column (in direction Y) are separated by an interval wall 5324 such that interval wall 5324 corresponds to one slider pocket 5325. One side of each interval wall 5324 that forms an inner wall of the corresponding slider pocket 5325 is an incline 5320, and all the inclines 5320 incline to the same side and parallel with each other. The opposite side to every incline 5320 is about a vertical wall such that the interval wall 5324 has a structure tapering from the bottom up and the slider pocket 5325 has a big-end-up structure, which is convenient for guiding the sliders in every column (in direction Y) into the slider pockets 5325 in the corresponding column (in direction Y), and in turn, makes sure that the adjacent sliders in the same column (in direction Y) are separated. A vertical cross-section of the slider pocket 5325 is about a triangle and the bottom of the slider pocket 5325 is further recessed to form a square recess 5328. Every slider pocket 5325 defines a though hole 5327 in the incline 5320 of the interval wall 5324 which runs through the upper debonding tray 532 so as to make the solution soak in, and in turn, speed dissolving the adhesive between the slider and the exposure jig, therefore debond the sliders quickly. In addition, we can grip the sliders with vacuum through the through holes 5327 to prevent the sliders moving after they drop into the slider pockets. In this embodiment, all inclines 5320 of the interval walls 5324 of the upper debonding tray 532 incline to the same direction. It can be understood that the angle between the incline 5320 of the interval wall 5324 and the level can be chosen in the range from 10 to 50 degree.

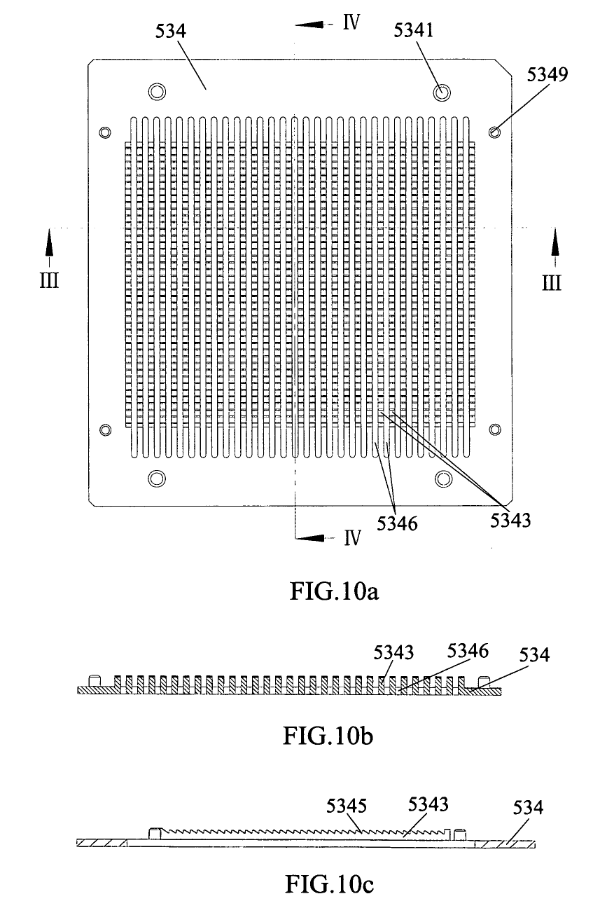

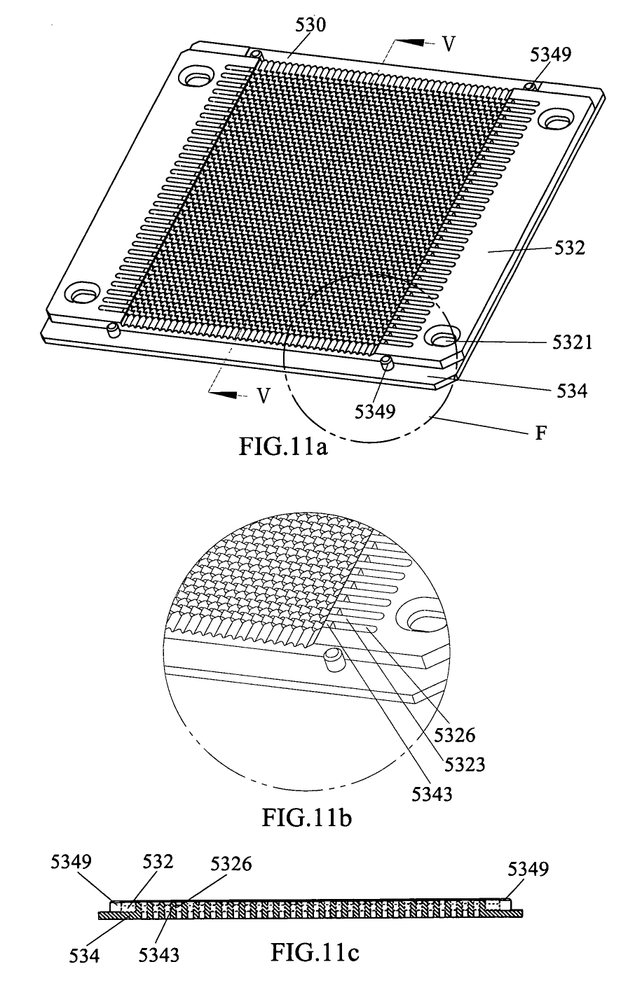

Referring to FIG. 8a, FIG. 8c and FIGS. 10a-10e, the lower debonding tray 534 is roughly square. As shown in FIG. 10a, the lower debonding tray 534 defines a bottom mounting hole 5341 at the left and right portions of the front and rear sides respectively and a guiding post 5349 extended upward at the front and rear portions of the left and right sides respectively. The guiding post 5349 can be integrated with the lower debonding tray 534 or individual elements mounted on the debonding tray 540 by mechanical fixing, both of which are well known to persons ordinarily skilled in the art, and a detailed description of which is omitted herefrom. The bottom mounting hole 5341 and the top mounting hole 5321 of the upper debonding tray 532 are used in conjunction with each other and engaged with each other by connecting elements, such as screws, bolts, or whatever. As shown in FIG. 10b, the lower debonding tray 534 forms a plurality of parallel ribs 5343 extending forward and backward on the top surface thereof. The guiding posts 5349 at two sides of the lower debonding tray 534 block the sides 5329 of the upper debonding tray 532 so as to align the slots 5326 of the upper debonding tray 532 with the ribs 5343 of the lower debonding tray 534 and take the ribs 5343 of the lower debonding tray 534 to insert into the slots 5326 of the upper debonding tray 532, referring to FIG. 11a. The lower debonding tray 534 provides a through slot 5346 between every two adjacent ribs 5343 to engage with the crossbeam 5323 of the upper debonding tray 532. The crossbeams 5323 are sandwiched between the adjacent through slots 5346 such that the upper debonding tray 532 and the lower debonding tray 534 can be assembled to a one-piece structure. As shown in FIGS. 10c-10e, a top surface 5342 of each rib 5343 forms a column of slider pockets 5345. Every two adjacent slider pockets 5345 in each column (in direction Y) are separated by an interval wall 5344 such that every interval wall 5344 corresponds to one slider pocket 5345. One side of each interval wall 5344 that forms an inner wall of the corresponding slider pocket 5345 is an incline 5340, and all the inclines 5340 incline to the same side and parallel with each other. The opposite side to the incline 5340 is about a vertical wall such that the interval wall 5344 has a structure tapering from the bottom up and the slider pocket 5345 has a big-end-up structure, which is convenient for guiding the sliders in every column (in direction Y) into the slider pockets 5345 in the corresponding column (in direction Y), and in turn, makes sure that the adjacent sliders in the same column (in direction Y) are separated. A vertical cross-section of the slider pocket 5345 is about a triangle and the bottom of the slider pocket 5345 is further recessed to form a square recess 5348. Every slider pocket 5345 defines a though hole 5347 in the incline 5340 of the interval wall 5344 which runs through the lower debonding tray 534 so as to make the solution soak in, and in turn, speed resolving the adhesive between the slider and the exposure jig, therefore debond the sliders quickly. In addition, we can grip the sliders with vacuum through the through holes 5347 to prevent the sliders moving after they drop into the slider pockets. In this embodiment, all inclines 5340 of the interval walls 5344 of the lower debonding tray 534 incline to the same direction. It can be understood that the angle between the incline 5340 of the interval wall 5344 and the level can be chosen in the range from 10 to 50 degree.

FIGS 11a-11e illustrate a structure of the debonding tray 530 after assembled. The upper debonding tray is mounted on the lower debonding tray 534, and the lower debonding tray 534 blocks two sides 5329 of the upper debonding tray 532 with the guiding posts 5349 formed on two sides of the lower debonding tray 534. The guiding posts 5439 lead the slots 5326 of the upper debonding tray 532 to align with the ribs 5343 of the lower debonding tray 534, while the ribs 5343 of the lower debonding tray 534 insert into the corresponding slots 5326 of the upper debonding tray 532. The slots of the lower debonding tray 534 (not shown in the figures) align with the crossbeams 5323 of the upper debonding tray 532 such that the slider pockets 5325 of the upper debonding tray 532 and the slider pockets 5345 of the lower debonding tray 534 are stagger arrangement and the inclines 5320 of the upper debonding tray 532 incline to opposite side to which the inclines 5340 of the lower debonding tray 534 incline. The bottom mounting holes 5341 and the top mounting hole 5321 of the upper debonding tray 532 are used with some connection elements, such as screws and bolts or whatever, so as to fasten the upper debonding tray 532 and the lower debonding tray 534, and in turn, form the debonding tray 530. Every two adjacent slider pockets 5325/5345 in each column (in direction Y) are separated by an interval wall 5324/5344, and one side of each interval wall 5324/5344 in every column is an incline 5320/5340 such that the interval wall 5324/5344 has a structure tapering from the bottom up and the slider pocket 5325/5345 has a big-end-up structure, which is convenient for guiding the sliders in every column (in direction Y) into the slider pockets 5325/5345 in the corresponding column (in direction Y), and in turn, makes sure that the adjacent sliders in the same column (in direction Y) are separated. As shown in FIGS. 11d-11e, since the inclines 5320 and 5340 of every two adjacent interval walls 5324 and 5344 in every row (in direction X) incline to opposite sides such that the plane of the incline 5325 is crossed with the plane of the incline 5345, the two interval walls 5324/5344 form side walls of the two adjacent slider pockets 5345/5325 corresponding to the two adjacent interval walls 5345/5325, respectively, so as to limit the sliders' movement, and in turn, prevent the adjacent sliders in rows (in direction X) from mixing, thus, make sure that the adjacent sliders in the same row (in direction X) are separated. In addition, every two adjacent interval walls 5324/5344 in every row provide a gap 536 to make the solution soak in, and in turn, speed dissolving the adhesive between the sliders and the exposure jig, therefore debond the sliders quickly.

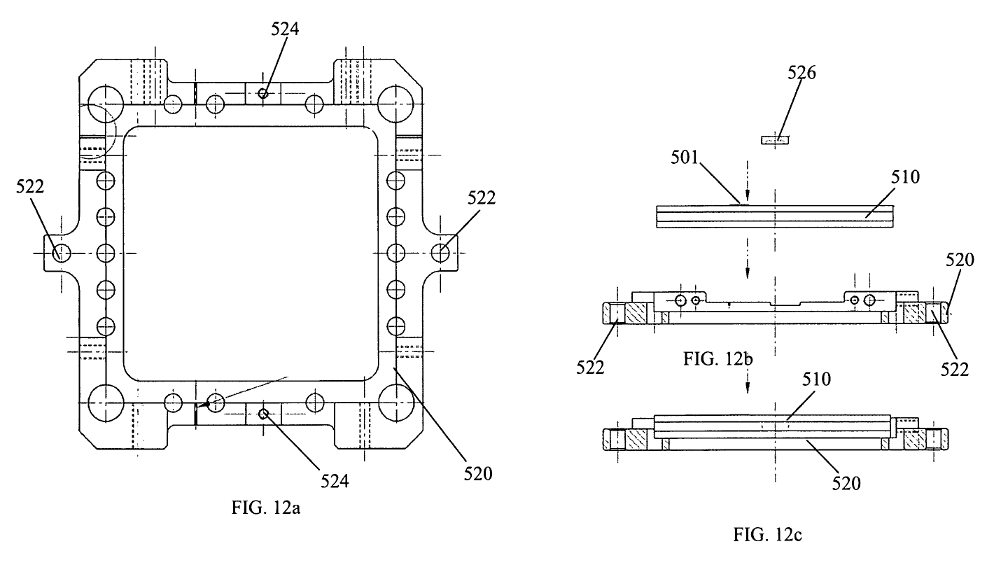

FIGS. 12a-12b show the exposure jig holder 520 and the assembling process of the exposure jig 510 and the exposure jig holder 520, respectively. The exposure jig holder 520 is about a square frame which is hollowed out in the center thereof and has four side bars connecting with their adjacent side bars respectively. The left and right side bars each have an aligning hole 522 at the middle positions thereof, while the front and rear side bars each defines a mounting hole 524 at the middle positions thereof. The aligning holes 522 are used to engage with the aligning pillar 542 of the debonding tray holder 540. The mounting holes 524 are used with second connection elements 526, which may be frequently-used screws or whatever, to fix the exposure jig 510 to the exposure jig holder 520.

Referring to FIG. 5b again, after the exposure jig 510 is fixed on the exposure jig holder 520, the aligning pillars 542 of the debonding tray holder 540 are inserted into the aligning holes 522, which makes the sliders to align with the slider pockets one to one so as to form an intact auxiliary fixture 500 for debonding the siders.

FIG. 13 shows the state that the auxiliary fixture 500 of the present invention is horizontally positioned in the solution 580 with NMP or IPA. In order to speed debonding the sliders 501 from the exposure jig 510, an ultrasonic device 590 is mounted at the bottom of the container to provide vibration when the sliders 501 are soaking in the solution 580 in the container. Referring to FIGS. 15a-15c, the sliders 501 are bonded to the exposure jig 510 which is positioned above the debonding tray 530. The sliders 501 are one-to-one alignment with the slider pockets 5325/5345 by the cooperation of the aligning holes 522 of the exposure jig holder 520 and the aligning pillars 542 of the debonding tray holder 540. When the auxiliary fixture 500 is soaked in the container with the solution 580 of NMP or IPA inside, the solution 580 dissolves the adhesive on the exposure jig 510 such that the sliders 501 debond from the exposure jig 510 and drop into the slider pockets 5325/5345 thereunder by gravity, accordingly, the debonding and receiving of the sliders 501 are completed.

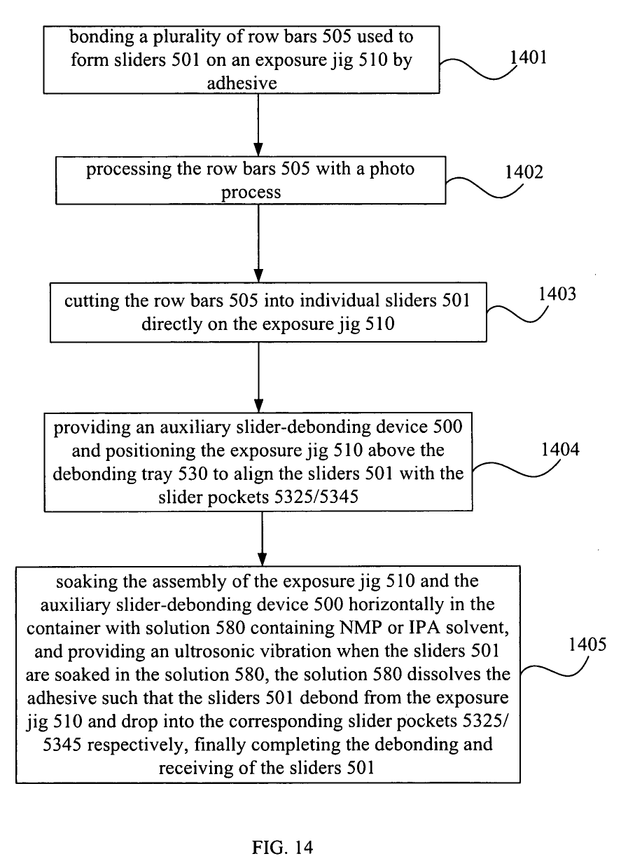

FIG. 14 shows a flow chart of a method for manufacturing sliders with the auxiliary fixture 500 of the present invention. The method includes the following steps: step 1401, bonding a plurality of row bars 505 used to form sliders 501 on an exposure jig 510 by adhesive; step 1402, processing the row bars 505 with a photo process; step 1403, cutting the row bars 505 into individual sliders 501 directly on the exposure jig 510, the sliders from one row bar are in a row, and every column of sliders are from different row bars; step 1404, providing an auxiliary fixture 500 and positioning the exposure jig 510 above the debonding tray 530 to align the sliders 501 with the slider pockets 5325/5345, and more concretely, aligning a row of sliders cut from one row bar with a row of slider pockets of the debonding tray and aligning a column of sliders from different row bars with a column slider pockets of debonding tray; step 1405, soaking the assembly of the exposure jig 510 and the auxiliary fixture 500 horizontally in the container with solution 580 containing NMP or IPA solvent, and providing an ultrasonic vibration when the sliders 501 are soaked in the solution 580. The solution 580 dissolves the adhesive such that the sliders 501 debond from the exposure jig 510 and drop into the corresponding slider pockets 5325/5345 respectively, finally completing the debonding and receiving of the sliders 501.

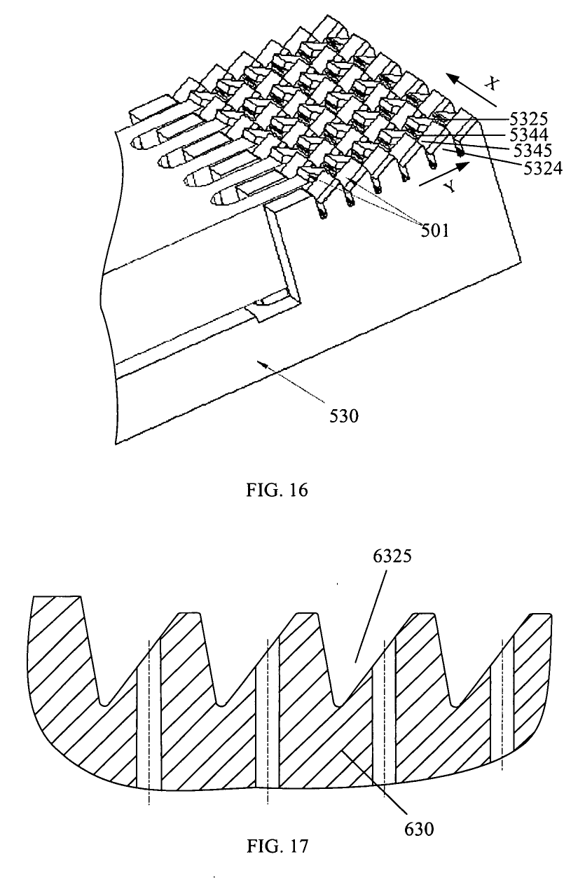

FIG. 16 illustrates the state that the sliders 501 on the exposure jig 510 debond from the exposure jig 510 and drop into slider pockets 5325/5345 of the debonding tray 530. Every two adjacent slider pockets 5325/5345 in each column (in direction Y) are separated by an interval wall 5324/5344, and one side of each interval wall 5324/5344 in every column is an incline 5320/5340 such that the interval wall 5324/5344 has a structure tapering from the bottom up and the slider pocket 5325/5345 has a big-end-up structure, which is convenient for guiding the sliders in every column (in direction Y) into the slider pockets 5325/5345 in the corresponding column (in direction Y), and in turn, makes sure that the adjacent sliders in the same column (in direction Y) are separated. And since the inclines 5320/5340 of every two adjacent interval walls 5324/5344 in every row (in direction X) incline to opposite sides such that the planes of the inclines 5325 are crossed with the planes of the inclines 5345, every two interval walls 5324/5344 form side walls of the two adjacent slider pockets 5345/5325 corresponding to the two adjacent interval walls 5345/5325, respectively, so as to limit the sliders' movement, and in turn, prevent the adjacent sliders in rows (in direction X) from mixing, thus, make sure that the adjacent sliders in the same row (in direction X) are separated. Accordingly, the sliders 501 drop into the corresponding slider pockets 5325/5345 so as to make sure that the sliders 501 are not mixed with each other.

Since the auxiliary fixture 500 for debonding sliders can debond the sliders in an array which has small spaces between every two adjacent columns and every two adjacent rows of the array, from the exposure jig and accurately receive the sliders in the debonding tray 530, so the row bars can be cut into sliders directly on the exposure jig rather and do not need to transfer the row bars, and in turn, saves one bonding procedure and one debonding procedure, that is to say, the whole process of manufacturing sliders only needs one bonding procedure and one debonding procedure, therefore simplifying the process and increasing the efficiency.

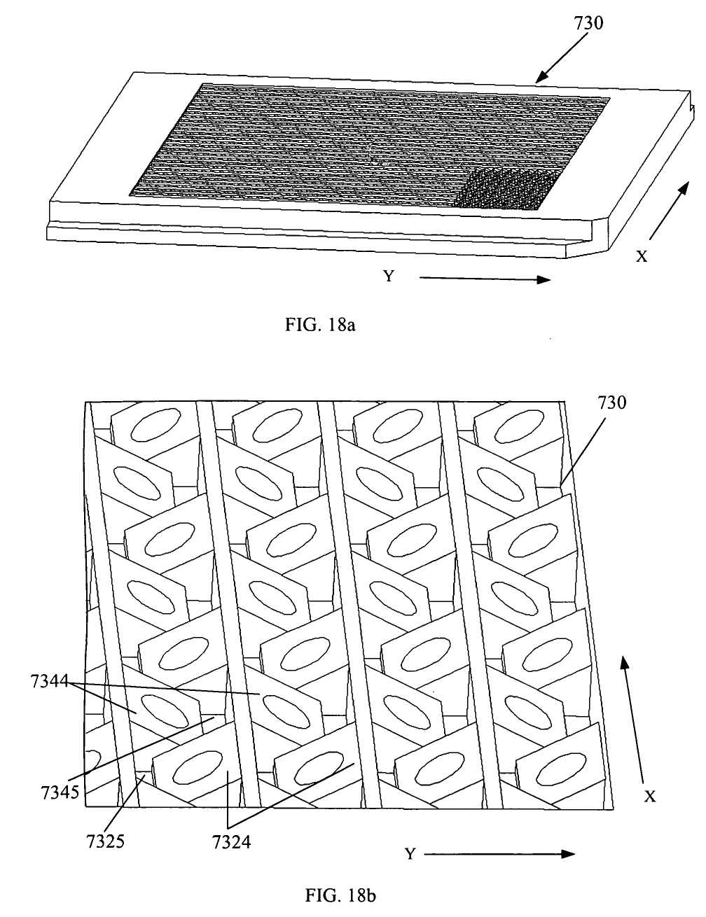

A second embodiment of the debonding tray according to the present invention is shown in FIG. 17. This embodiment is similar to the aforementioned embodiment, and the difference is that the bottom of the slider pocket 6325 formed on the debonding tray 630 are not recessed downward to form a square slot. Of course, the second embodiment can achieve the same function of the first embodiment.

A third embodiment of the debonding tray according to the present invention is shown in FIGS. 18a-18b. A debonding tray 730 is one-piece in structure and defines a plurality of slider pockets 7325/7345 arranged in an array on the top surface thereof. Every two adjacent slider pockets 7325/7345 in each column (in direction Y) are separated by an interval wall 7324/7344 such that the interval wall 7324/7344 corresponds to one slider pocket 7325/7345. One side of each interval wall 7324/7344 that forms an inner wall of the corresponding slider pocket 7325/7345 is an incline such that the interval wall 7324/7344 has a structure tapering from the bottom up and the slider pocket 7325/7345 has a big-end-up structure, which is convenient for guiding the sliders in every column (in direction Y) into the slider pockets 7325/7345 in the corresponding column (in direction Y), and in turn, makes sure that the adjacent sliders in the same column (in direction Y) are separated. The inclines of the interval walls in the same column in direction Y incline to the same side and parallel with each other, while the inclines of the interval walls in every two adjacent columns are crossed with each other such that the planes of the two inclines of the two adjacent interval walls 7324/7344 in the same row (in direction X) are crossed with each other. The two interval walls 7324/7344 form side walls of the two adjacent slider pockets 7345/7325 corresponding to the two adjacent interval walls 7345/7325, respectively, so as to limit the sliders' movement, and in turn, prevent the adjacent sliders in rows (in direction X) from mixing, thus, make sure that the adjacent sliders in the same row (in direction X) are separated. Accordingly, the sliders debonded from the exposure jig can drop into the corresponding slider pockets 7325/7345 and get no confusion, finally achieving the same effect as the first embodiment.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An auxiliary fixture for debonding sliders from an exposure jig and housing the sliders, comprising:
a debonding tray, a top surface of the debonding tray forming a plurality of slider pockets arranged in an array, every two adjacent slider pockets in every column of the array being separated by an interval wall such that every interval wall corresponds to one slider pocket, wherein one side of each interval wall that forms an inner wall of the corresponding slider pocket is an incline such that the interval wall has a structure tapering from the bottom up, the inclines of the interval walls in the same column of the array incline to the same side and the inclines of the interval walls in two adjacent columns of the array incline to opposite sides such that every two adjacent interval walls in every row of the array form side walls of each other's slider pockets.

2. The auxiliary fixture according to claim 1, wherein the debonding tray comprises an upper debonding tray and a lower debonding tray.

3. The auxiliary fixture according to claim 2, wherein the upper debonding tray defines a plurality of parallel slots and forms a crossbeam between every two adjacent slots, a top surface of each crossbeam forms a column of the slider pockets, and all the inclines of the interval walls formed on the upper debonding tray incline to the same direction, the lower debonding tray forms a plurality of parallel ribs, a top surface of each rib forms a column of the slider pockets, and all the inclines of the interval walls formed on the lower debonding tray incline to the same direction which is opposite to the direction to which the inclines of the upper debonding tray incline, the ribs of the lower debonding tray insert into the corresponding slots of the upper debonding tray.

4. The auxiliary fixture according to claim 3, wherein the lower debonding tray has guiding posts at two sides thereof to guide the slots of the upper debonding tray to receive the corresponding ribs of the lower debonding tray.

5. The auxiliary fixture according to claim 3, wherein the lower debonding tray provides a through slot between every two adjacent ribs.

6. The auxiliary fixture according to claim 1, wherein the debonding tray is one-piece in structure.

7. The auxiliary fixture according to claim 1, wherein a vertical cross-section of the slider pocket is about a triangle.

8. The auxiliary fixture according to claim 1, wherein the bottom of the slider pocket is further recessed to form a recess.

9. The auxiliary fixture according to claim 1, wherein the angle between the incline of the interval wall and the level is in the range from 10 to 50 degree.

10. The auxiliary fixture according to claim 1, wherein the debonding tray defines a through hole in the incline of each interval wall.

11. The auxiliary fixture according to claim 1, wherein between every two adjacent interval walls in each row of the array there is a gap.

12. The auxiliary fixture according to claim 1, further comprising a debonding tray holder configured to fix the debonding tray, the debonding tray holder having supporting legs thereunder.

13. The auxiliary fixture according to claim 12, further comprising an exposure jig holder configured to fix the exposure jig, the exposure jig holder and the debonding tray holder having a plurality of aligning pillars and a plurality of aligning holes engaging with each other.

14. A method for manufacturing sliders using the auxiliary fixture as claimed in claim 1, comprising steps of:
(1) bonding a plurality of row bars to an exposure jig by adhesive;
(2) processing the row bars with a photo process;
(3) cutting the row bars into individual sliders directly on the exposure jig;
(4) providing an auxiliary fixture as claimed in claim 1, and positioning the exposure jig above the debonding tray with the sliders being one-to-one alignment with the slider pockets; and
(5) soaking the assembly of the exposure jig and the auxiliary fixture horizontally in a container with some solution inside, dissolving the adhesive with the solution to make the sliders debond from the exposure jig and drop into the corresponding slider pockets.

15. The method for manufacturing sliders according to claim 14, wherein the solution is some solution containing N-Methyl Pyrrolidone or Isopropyl Alcohol solvent.

16. The method for manufacturing sliders according to claim 14, further comprising a step of providing ultrasonic vibration when the sliders are soaked in the solution.

17. The method for manufacturing sliders according to claim 14, wherein in the step (4), a row of sliders cut from one row bar are aligned with a row of slider pockets of the debonding tray and a column of sliders from different row bars are aligned with a column of slider pockets of the debonding tray.

18. The method for manufacturing sliders according to claim 14, wherein in the step (4), the debonding tray comprises an upper debonding tray and a lower debonding tray.

19. The method for manufacturing sliders according to claim 18, wherein the upper debonding tray defines a plurality of parallel slots and forms a crossbeam between every two adjacent slots, a top surface of each crossbeam forms a column of the slider pockets, and all the inclines of the interval walls formed on the upper debonding tray incline to the same direction, the lower debonding tray forms a plurality of parallel ribs formed, a top surface of each rib forms a column of the slider pockets, and all the inclines of the interval walls formed on the lower debonding tray incline to the same direction which is opposite to the direction to which the inclines of the upper debonding tray incline, the ribs of the lower debonding tray insert into the corresponding slots of the upper debonding tray.

20. The method for manufacturing sliders according to claim 18, wherein in the step (4), the auxiliary fixture further comprises a debonding tray holder having supporting legs thereunder, the debonding tray is fixed on the debonding tray holder.

21. The method for manufacturing sliders according to claim 20, wherein in the step (4), the auxiliary fixture further comprises an exposure jig holder, the exposure jig holder and the debonding tray holder have a plurality of aligning pillars and a plurality of aligning holes engaging with each other, the exposure jig is fixed on the exposure jig holder and then the aligning pillars are inserted to the corresponding aligning holes such that the sliders are one-to-one alignment with the slider pockets.
